(19) United States
(12) Patent Application Publication
(10) Pub. No.: US 2024/0037407 A1
(43) Pub. Date: Feb. 1, 2024

(54) LEARNING APPARATUS, TRAINED MODEL GENERATION METHOD, CLASSIFICATION APPARATUS, CLASSIFICATION METHOD, AND COMPUTER READABLE RECORDING MEDIUM

(71) Applicant: NEC Corporation, Minato-ku, Tokyo (JP)

(72) Inventor: Atsushi SATO, Tokyo (JP)

(73) Assignee: NEC Corporation, Minato-ku, Tokyo (JP)

(21) Appl. No.: 18/021,089

(22) PCT Filed: Aug. 20, 2020
(86) PCT No.: PCT/JP2020/031512

§ 371 Date: Feb. 13, 2023

(51) Int. Cl. G06N 3/09

(52) U.S. Cl. CPC G06N 3/09

(57) ABSTRACT

A learning apparatus includes: a score calculation unit that calculates scores by inputting training data with positive or negative labels to a score function; a score specification unit that specifies the lowest one of the scores for the training data with positive labels as a minimum score, and specifies the highest one of the scores for the training data with negative labels as a maximum score; a pair generation unit that selects training data for which the scores are equal to or higher than the minimum and equal to or lower than the maximum, and generates pairs of a positive example and a negative example, and an optimization unit that updates a parameter of the score function through machine learning so as to increase the number of pairs in which a score of training data with positive label is higher than a score of training data with negative label.

### TECHNICAL FIELD

The present invention relates to a learning apparatus and a trained model generation method for performing machine learning of a parameter of a score function used in binary classification, and further relates to a classification apparatus and a classification method that perform binary classification, and further relates to a computer readable recording medium on which a program for realizing them has been recorded.

### BACKGROUND ART

In binary classification for determining whether observation data is in a positive example class or a negative example class, machine learning of a parameter of a score function that outputs a score is performed in accordance with the observation data, and a trained model that performs binary classification is generated. Binary classification is used in, for example, video surveillance, failure diagnosis, item inspections, medical image diagnosis, and so forth that use image data.

As a method of machine learning in binary classification, a learning method for learning a parameter of a score function so as to maximize the AUC (Area Under the Curve) (hereinafter referred to as a “learning method that uses the AUC”) is known (see Non-Patent Document 1, for example). In general, binary classification easily gives rise to a situation where the number of training data pieces in a positive example class is extremely small compared to the number of training data pieces in a negative example class; it is known that, even in such a case, high classification accuracy is achieved with use of the AUC.

Also, a partial AUC (hereinafter referred to as “pAUC”), which has been improved so as to maximize a part of the AUC in order to refine the true positive rate at the time when a low false positive rate has been set, has also been suggested (see Non-Patent Document 2, for example). A learning method for learning a parameter of a score function so as to maximize the pAUC (hereinafter referred to as a “learning method that uses the pAUC) is disclosed in, for example, Patent Document 1.

A description is now given of the AUC and the pAUC with use of FIG. 9 and FIG. 10. FIG. 9A is a diagram for describing the AUC, and FIG. 9B is a diagram for describing the pAUC. FIG. 10A is a diagram showing examples of pairs of a positive example and a negative example necessary for calculation of the AUC, and FIG. 10B is a diagram showing examples of pairs of a positive example and a negative example necessary for calculation of the pAUC.

FIGS. 9A and 9B show an ROC (Receiver Operating Characteristic) curve. The ROC curve is a curve obtained by plotting true positive rates (vertical axis) and false positive rates (horizontal axis) while changing a threshold for deciding on positive examples and negative examples in relation to a score function. Also, the true positive rate indicates the rate of correct detection whereby data in a positive example class is correctly classified into the positive example class, whereas the false positive rate indicates the rate of false detection whereby data in a negative example class is erroneously classified into a positive example class.

As shown in FIG. 9A, the AUC represents the area of a region on the horizontal axis side (lower side) of the ROC (Receiver Operating Characteristic) curve. Furthermore, as shown in FIG. 9B, the pAUC is the value of the AUC obtained when a certain fixed value β is used as the value of the false positive rate, and represents the area of a region enclosed by the ROC curve, the horizontal axis, and the vertical axis that passes through the fixed value β.

### LIST OF RELATED ART DOCUMENTS

### Patent Document

Patent Document 1: Japanese Patent Laid-Open Publication No. 2017-102540

### NON PATENT DOCUMENT

Non-Patent Document 1: C. Cortes and M. Mohri, AUC optimization vs. error rate minimization, In Advance in Neural Information Processing Systems, MIT Press, 2004.

Non-Patent Document 2: H. Narasimhan and S. Agarwal, “A Structural SVM Based Approach for Optimizing Partial AUC”, Int'l Conf. on Machine Learning (ICML), 2013.

### SUMMARY OF INVENTION

### Problems to be Solved by the Invention

However, as shown in FIG. 10(a), in the case of the learning method that uses the AUC, it is necessary to configure pairs so that all possible pairs of a positive example and a negative example are exhaustively set, and calculate the AUC with use of every pair that has been configured. Therefore, the learning method that uses the AUC has a problem that the amount of calculation is large and machine learning takes time. Here, s⁺ᵢ denotes the scores of N⁺ training data pieces in a positive example class, and s⁻ⱼ denotes the scores of N⁻ training data pieces in a negative example class. Among the pairs that are shown in gray in FIG. 10(a), the total number of pairs in which s⁺ᵢ is larger than s⁻ⱼ is divided by N⁺×N⁻, and the resultant value is used as the AUC.

On the other hand, in the case of the learning method that uses the pAUC, training data pieces in the negative example class are sorted in descending order of score values, and the pAUC is calculated using pairs of data pieces in the negative example class included in the pre-set false positive rate β and all data pieces in the positive example class, as shown in FIG. 10(b). Specifically, among the pairs that are shown in gray in FIG. 10(b), the total number of pairs in which s⁺ᵢ is larger than s⁻ⱼ is divided by N⁺×βN⁻, and the resultant value is used as the pAUC. Therefore, the number of pairs for which calculation is to be performed can be reduced compared to the learning method that uses the AUC. However, even in the case of the learning method that uses the pAUC, the number of pairs for which calculation is necessary is still large, and there is a demand for a further reduction in the amount of calculation.

An example object of the present invention is to solve the aforementioned problem, and to shorten a time period required for machine learning in machine learning of a parameter of a score function used in binary classification.

### Means for Solving the Problems

In order to achieve the above-described object, a learning apparatus for performing machine learning of a score function for binary classification according to an example aspect of the invention, includes:
a score calculation unit that calculates scores by inputting, to the score function, a plurality of training data pieces to which labels of positive examples or negative examples have been added;
a score specification unit that specifies the lowest one of the scores that have been calculated for the training data pieces to which the labels of positive examples have been added as a minimum score, and specifies the highest one of the scores that have been calculated for the training data pieces to which the labels of negative examples have been added as a maximum score;
a pair generation unit that selects, from among the training data pieces to which the labels of positive examples have been added and from among the training data pieces to which the labels of negative examples have been added, training data pieces for which the calculated scores are equal to or higher than the minimum score and equal to or lower than the maximum score, and generates a group of pairs of a positive example and a negative example from the selected training data pieces; and
an optimization unit that updates a parameter of the score function through machine learning so as to, with regard to the generated group of pairs, increase the number of pairs in which a score of training data to which a label of a positive example has been added is higher than a score of training data to which a label of a negative example has been added.

In addition, in order to achieve the above-described object, a trained model generation method for performing machine learning of a score function for binary classification according to an example aspect of the invention includes:
a score calculation step of calculating scores by inputting, to the score function, a plurality of training data pieces to which labels of positive examples or negative examples have been added;
a score specification step of specifying the lowest one of the scores that have been calculated for the training data pieces to which the labels of positive examples have been added as a minimum score, and specifying the highest one of the scores that have been calculated for the training data pieces to which the labels of negative examples have been added as a maximum score;
a pair generation step of selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces; and
an optimization step of updating a parameter of the score function through machine learning so as to, with regard to the generated group of pairs, increase the number of pairs in which a score of training data to which a label of a positive example has been added is higher than a score of training data to which a label of a negative example has been added.

Furthermore, in order to achieve the above-described object, a first computer readable recording medium according to an example aspect of the invention is a computer readable recording medium that includes recorded thereon a program to cause a computer perform machine learning of a score function for binary classification, the program including instructions that cause the computer to carry out:
a score calculation step of calculating scores by inputting, to the score function, a plurality of training data pieces to which labels of positive examples or negative examples have been added;
a score specification step of specifying the lowest one of the scores that have been calculated for the training data pieces to which the labels of positive examples have been added as a minimum score, and specifying the highest one of the scores that have been calculated for the training data pieces to which the labels of negative examples have been added as a maximum score;
a pair generation step of selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces; and
an optimization step of updating a parameter of the score function through machine learning so as to, with regard to the generated group of pairs, increase the number of pairs in which a score of training data to which a label of a positive example has been added is higher than a score of training data to which a label of a negative example has been added.

In order to achieve the above-described object, a classification apparatus according to an example aspect of the invention includes:
a score calculation unit that calculates scores by inputting test data pieces to a score function; and
a classification unit that classifies the test data pieces into two classes based on values of the calculated scores,
wherein
the score function is a function obtained by
   using the lowest one of scores that have been calculated for training data pieces to which labels of positive examples have been added as a minimum score, and using the highest one of scores that have been calculated for training data pieces to which labels of negative examples have been added as a maximum score,
   selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces, and
   performing machine learning of a parameter of the score function so as to, with regard to the generated group of pairs, increase the number of pairs in which a score of training data to which a label of a positive example has been added is higher than a score of training data to which a label of a negative example has been added.

In addition, in order to achieve the above-described object, a classification method according to an example aspect of the invention includes:
a score calculation step of calculating scores by inputting test data pieces to a score function; and
a classification step of classifying the test data pieces into two classes based on values of the calculated scores,
wherein
the score function is a function obtained by
   using the lowest one of scores that have been calculated for training data pieces to which labels of positive examples have been added as a minimum score, and using the highest one of scores that have been calculated for training data pieces to which labels of negative examples have been added as a maximum score,
   selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces, and
   performing machine learning of a parameter of the score function so as to, with regard to the generated group of pairs, increase the number of pairs in which a score of training data to which a label of a positive example has been added is higher than a score of training data to which a label of a negative example has been added.

Furthermore, in order to achieve the above-described object, a second computer readable recording medium according to an example aspect of the invention is a computer readable recording medium that includes recorded thereon a program,
the program including instructions that cause a computer to carry out:
a score calculation step of calculating scores by inputting test data pieces to a score function; and
a classification step of classifying the test data pieces into two classes based on values of the calculated scores,
wherein
the score function is a function obtained by
   using the lowest one of scores that have been calculated for training data pieces to which labels of positive examples have been added as a minimum score, and using the highest one of scores that have been calculated for training data pieces to which labels of negative examples have been added as a maximum score,
   selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces, and
   performing machine learning of a parameter of the score function so as to, with regard to the generated group of pairs, increase the number of pairs in which a score of training data to which a label of a positive example has been added is higher than a score of training data to which a label of a negative example has been added.

### Advantageous Effects of the Invention

As described above, according to the invention, it is possible to shorten a time period required for machine learning in machine learning of a parameter of a score function used in binary classification.

### BRIEF DESCRIPTION OF THE DRAWINGS

FIG. 1 is a configuration diagram showing a schematic configuration of a learning apparatus according to the first example embodiment.

FIG. 2 is a configuration diagram specifically showing the configuration of the learning apparatus according to the first example embodiment.

FIG. 3 is a diagram showing a relationship between the scores of positive examples and negative examples calculated in the first example embodiment and a probability density.

FIG. 4 is a diagram showing an example of a group of pairs generated in the first example embodiment.

FIG. 5 is a flow diagram showing the operations of the learning apparatus according to the first example embodiment.

FIG. 6 is a block diagram showing the configuration of the classification apparatus according to the second example embodiment.

FIG. 7 is a flow diagram showing the operations of the classification apparatus according to the second example embodiment.

FIG. 8 is a block diagram illustrating an example of a computer that realizes the learning apparatus according to the first example embodiment and the classification apparatus according to the second example embodiment.

FIG. 9A is a diagram for describing the AUC, and FIG. 9B is a diagram for describing the pAUC.

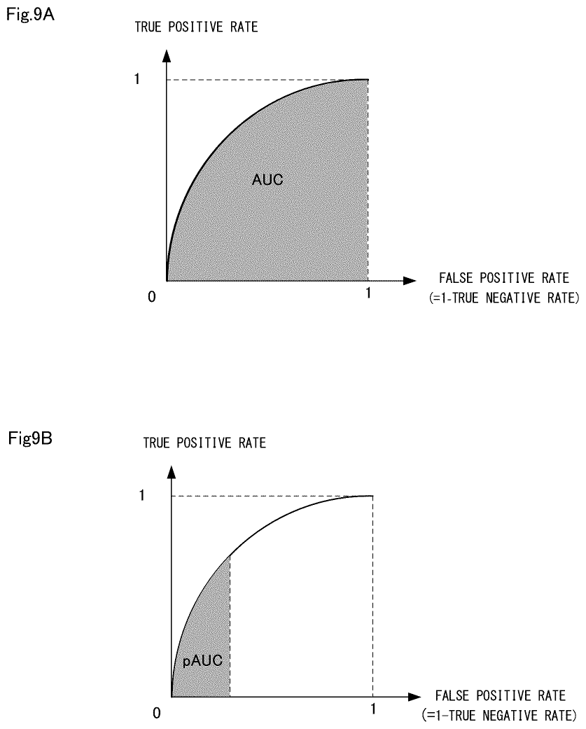

FIG. 10A is a diagram showing examples of pairs of a positive example and a negative example necessary for calculation of the AUC, and FIG. 10B is a diagram showing examples of pairs of a positive example and a negative example necessary for calculation of the pAUC.

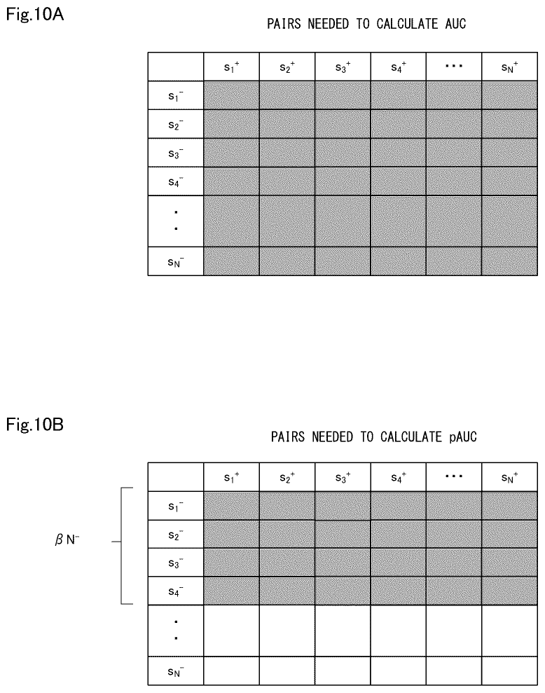

### EXAMPLE EMBODIMENT

### First Example Embodiment

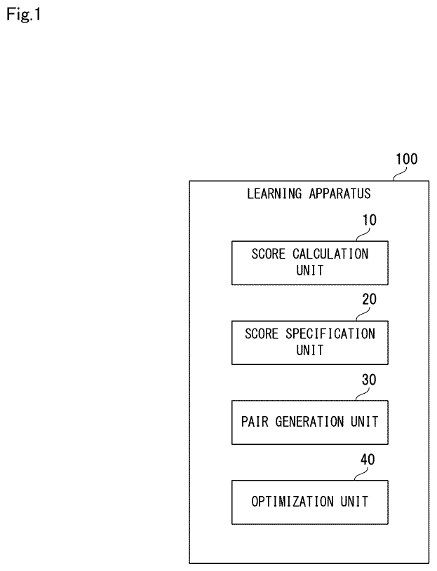

The following describes a learning apparatus, a trained model generation method, and a program according to a first example embodiment with reference to FIG. 1 to FIG. 5.

### Apparatus Configuration

First, a schematic configuration of a learning apparatus according to the first example embodiment will be described using FIG. 1. FIG. 1 is a configuration diagram showing a schematic configuration of a learning apparatus according to the first example embodiment.

A learning apparatus 100 according to the first example embodiment shown in FIG. 1 is an apparatus for performing machine learning of a score function for binary classification. As shown in FIG. 1, the learning apparatus 100 according to the first example embodiment includes a score calculation unit 10, a score specification unit 20, a pair generation unit 30, and an optimization unit 40.

The score calculation unit 10 calculates scores by inputting, to the score function, a plurality of training data pieces to which labels of positive examples or negative examples have been added. The score specification unit 20 specifies the lowest one of the scores calculated for training data pieces to which labels of positive examples have been added as a minimum score. Also, the score specification unit 20 specifies the highest one of the scores calculated for training data pieces to which labels of negative examples have been added as a maximum score. The pair generation unit 30 selects, from among training data pieces to which labels of

positive examples have been added and from among training data pieces to which labels of negative examples have been added, training data pieces for which the calculated scores are equal to or higher than the minimum score and equal to or lower than the maximum score, and generates a group of pairs of a positive example and a negative example from the selected training data pieces.

The optimization unit 40 updates a parameter of the score function through machine learning so as to, with regard to the group of pairs generated by the pair generation unit 30, increase the number of pairs in which the score of training data to which a label of a positive example has been added is higher than the score of training data to which a label of a negative example has been added.

As described above, according to the first example embodiment, training data pieces that are used in machine learning of the parameter of the score function are limited to training data pieces for which the scores are equal to or higher than the minimum score and equal to or lower than the maximum score. Therefore, according to the first example embodiment, in machine learning of the parameter of the score function used in binary classification, the time period required for machine learning can be shortened.

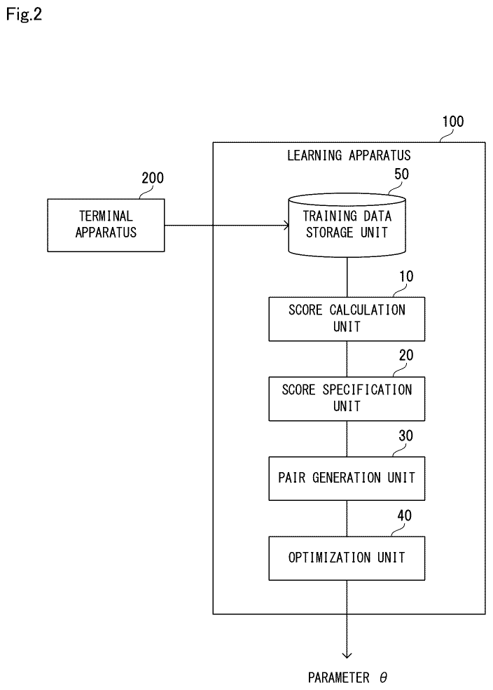

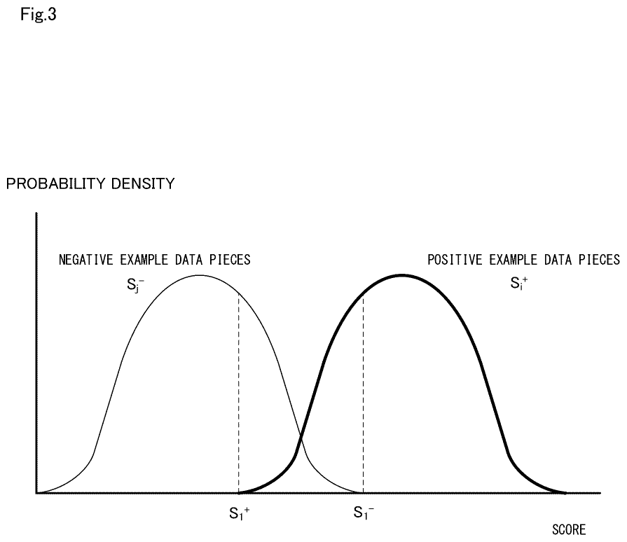

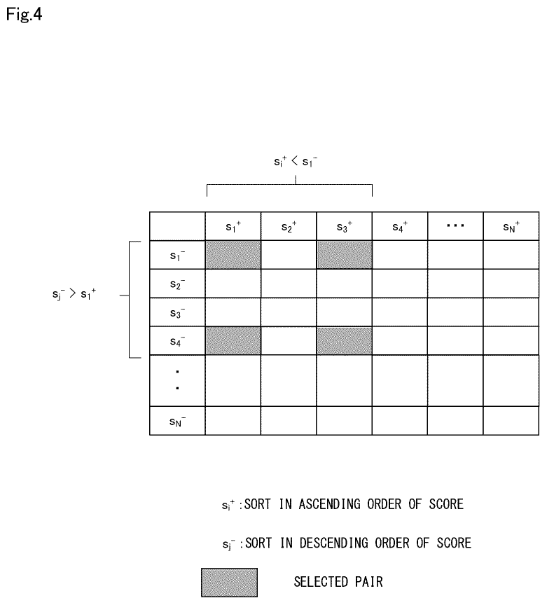

Next, the configuration and functions of the learning apparatus 100 according to the first example embodiment will be specifically described using FIG. 2 to FIG. 4. FIG. 2 is a configuration diagram specifically showing the configuration of the learning apparatus according to the first example embodiment. FIG. 3 is a diagram showing a relationship between the scores of positive examples and negative examples calculated in the first example embodiment and a probability density. FIG. 4 is a diagram showing an example of a group of pairs generated in the first example embodiment. As shown in FIG. 2, in the first example embodiment, the learning apparatus 100 is

connected to a terminal apparatus 200, which inputs training data pieces, in such a manner that data can be communicated therebetween. Specific examples of the terminal apparatus 200 include a general-purpose computer, a smartphone, a tablet-type terminal apparatus, and so forth.

Also, as shown in FIG. 2, in the first example embodiment, the learning apparatus 100 includes a training data storage unit 50 in addition to the score calculation unit 10, score specification unit 20, pair generation unit 30, and optimization unit 40 that have been described earlier.

The training data storage unit 50 stores training data pieces transmitted from the terminal apparatus 200. Training data pieces include positive examples and negative examples. In the first example embodiment, the score calculation unit 10 inputs each of the training

data pieces stored in the training data storage unit 50 to the score function, and calculates scores for the training data pieces, respectively. Here, it is assumed that the scores of training data pieces with labels of positive examples are Sᵢ⁺, and the scores of training data pieces with labels of negative examples are Sⱼ⁻. i and j denote integers equal to or larger than one. Also, the score function is defined as f(x;θ). x is data that is input to the score function, and θ is a parameter of the score function.

In the first example embodiment, as shown in FIG. 3, the score specification unit 20 specifies the lowest score (minimum score) S₁⁺ from among the scores Sᵢ⁺ of training data pieces to which labels of positive examples have been added (hereinafter referred to as “positive example data pieces”). Also, the score specification unit 20 specifies the highest score (maximum score) S₁⁻ from among the scores Sⱼ⁻ of training data pieces to which labels of negative examples have been added (hereinafter referred to as “negative example data pieces”). Furthermore, as shown in FIG. 3, in a case where the score distributions overlap, they bear a relationship S₁⁺<S₁⁻. First, the pair generation unit 30 selects training data pieces for which the scores are equal

to or higher than S₁⁺ and equal to or lower than S₁⁻ from among positive example data pieces and from among negative example data pieces (see FIG. 3); in the example embodiment, it randomly selects only a set number of training data pieces. Specifically, the pair generation unit 30 randomly selects m positive example data pieces (hereinafter referred to as a “set P”), and n negative example data pieces (hereinafter referred to as a “set N”). As a result, a group of pairs composed of a total of m×n (the set number) pairs is generated.

In the example of FIG. 4, two positive example data pieces (scores: S₁⁺, S₃⁺) are selected from among three positive example data pieces (scores: S₁⁺, S₂⁺, S₃⁺), and two negative example data pieces (scores: S₁⁻, S₄⁻) are selected from among four negative example data pieces (scores: S₁⁻, S₂⁻, S₃⁻, S₄⁻) . The number of pairs that compose the group of pairs is four. By adopting this mode, the number of pairs necessary for machine learning can be further reduced, and thus the time period required for machine learning can be further shortened.

In the first example embodiment, the optimization unit 40 updates the parameter θ of the score function f(x;θ) with use of, for example, hill climbing indicated by the following Math. 2as machine learning, so that the value of AUC (θ), which is obtained by applying the group of pairs generated by the pair generation unit 30 to the following Math. 1, is maximized. Hill climbing is one of search methods based on machine learning, and is a method of obtaining a final solution by repeatedly making a selection of data which is in the vicinity of certain data and which is closest to the correct answer, and a selection of data which is in the vicinity of the selected data and which is even closest to the correct answer.

In the following Math. 1, |P| and |N| and respectively denote the numbers of data pieces in the aforementioned set P and set N. Also, g(·) denotes a function obtained by rendering the 0-1 function differentiable. Specific examples of g(·) include a sigmoid function and no particular monotonically increasing function. In the following Math. 2, ε denotes a minute, positive real number.

$$AUC ( θ ) = \frac{1}{\vert P \vert \vert N \vert} {\sum }_{{x}_{i}^{+} ∈ P} {\sum }_{{x}_{j}^{-} ∈ N} g ( f ( {x}_{i}^{+} ; θ ) - f ( {x}_{j}^{-} ; θ ) ) \qquad [ Math . 1 ]$$

$$θ ← θ + ε \frac{\partial AUC ( θ )}{\partial θ} \qquad [ Math . 2 ]$$

Once the optimization unit 40 has executed updating processing with use of the above-mentioned Math. 1 and Math. 2 in the foregoing manner, the parameter θ of the score function is consequently updated so that the number of pairs in which the score of positive example data is higher than the score of negative example data is increased.

### Apparatus Operations

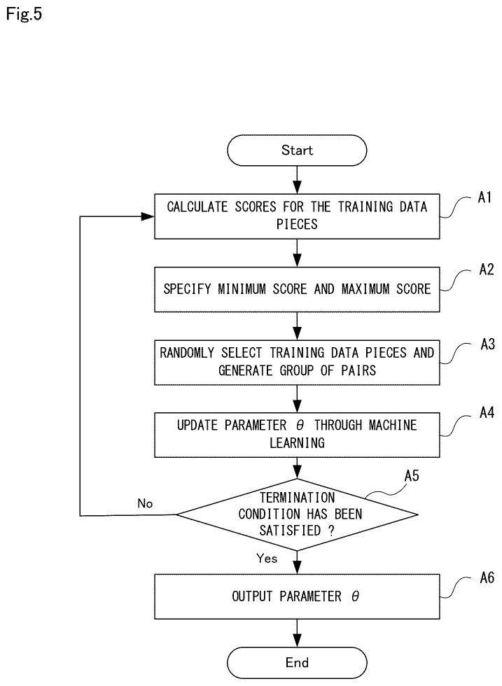

Next, the operations of the learning apparatus 100 according to the first example embodiment will be described using FIG. 5. FIG. 5 is a flow diagram showing the operations of the learning apparatus according to the first example embodiment. In the following description, FIG. 1 to FIG. 4 will be referred to as appropriate. Also, in the first example embodiment, the trained model generation method is implemented by causing the learning apparatus 100 to operate.

Therefore, the following description of the operations of the learning apparatus 100 applies to the trained model generation method according to the first example embodiment.

As shown in FIG. 5, first, the score calculation unit 10 obtains each of training data pieces stored in the training data storage unit 50, inputs each of the training data pieces to the score function f(x;θ), and calculates scores for the training data pieces, respectively (step A1). Note that in a case where step A5 to be described later has never been executed, an initial value is used as the value of the parameter θ.

Next, the score specification unit 20 specifies the minimum score S₁⁺ from among the scores Sᵢ⁺ of positive example data pieces calculated in step A1, and specifies the maximum score S₁⁻ from among the scores Sⱼ⁻ of negative example data pieces (step A2).

Next, the pair generation unit 30 randomly selects only a set number of training data pieces from among training data pieces for which the scores are equal to or higher than S₁⁺ and equal to or lower than S₁⁻, and generates a group of pairs using positive example data pieces and negative example data pieces of the selected training data pieces (step A3).

Next, while calculating the AUC (θ) by applying the group of pairs generated in step A3 to the above-mentioned Math. 1, the optimization unit 40 updates the parameter θ of the score function, with use of hill climbing indicated by the above-mentioned Math. 2 as machine learning, so that the value of the calculated AUC (θ) becomes the largest (step A4).

Next, the optimization unit 40 determines whether a termination condition has been satisfied (step A5). The termination condition is, for example, a condition where the range of fluctuation in the calculated value of the AUC (θ) when the parameter θ has been changed with use of hill climbing is small (the range of fluctuation is equal to or smaller than a threshold). In a case where the termination condition has not been satisfied as a result of

determination in step A5, the optimization unit 40 causes the score calculation unit 10 to execute step Al again with use of the updated parameter θ.

On the other hand, in a case where the termination condition has been satisfied as a result of determination in step A5, the optimization unit 40 outputs the parameter θ of the score function f(x;θ) calculated in step A4 (step A6).

### Advantageous Effects in First Example Embodiment

As described above, according to the first example embodiment, the parameter θ of the score function can be updated while reducing the number of pairs necessary for machine learning compared to conventional binary classification (see FIG. 4). Therefore, according to the first example embodiment, in machine learning of the parameter of the score function used in binary classification, the time period required for machine learning can be shortened.

### Example Modification

Next, an example modification of the first example embodiment will be described. In the example modification, the pair generation unit 30 selects, from among the generated pairs, pairs in which the score of positive example data is lower than the score of negative example data (the score of positive example data<the score of negative example data). Then, the pair generation unit 30 ultimately selects a set number of pairs randomly from among the selected pairs, and generates a group of pairs using the ultimately selected pairs.

As described above, the example modification makes it possible to narrow down the pairs that serve as options, and selects pairs that compose the group of pairs from among pairs that are small in number compared to the aforementioned example. Therefore, according to the example modification, the time period required for machine learning can be even further shortened.

### Program

It suffices for a program in the first example embodiment to be a program that causes a computer to carry out steps A1 to A6 shown in FIG. 5. Also, by this program being installed and executed in the computer, the learning apparatus 100 and the trained model generation method according to the first example embodiment can be realized. In this case, a processor of the computer functions and performs processing as the score calculation unit 10, the score specification unit 20, the pair generation unit 30 and the optimization unit 40.

In the first example embodiment, the training data storage unit 50 may be realized by a storage device such as a hard disk provided in the computer, or may be realized by a storage device of another computer.

The computer includes general-purpose PC, smartphone and tablet-type terminal device. Furthermore, the computer may be the terminal device 200 shown in FIG. 2. In this case, the learning apparatus 100 according to the first example embodiment is constructed on the operating system of the terminal device 200.

Furthermore, the program according to the first example embodiment may be executed by a computer system constructed with a plurality of computers. In this case, for example, each computer may function as one of the score calculation unit 10, the score specification unit 20, the pair generation unit 30 and the optimization unit 40.

### Second Example Embodiment

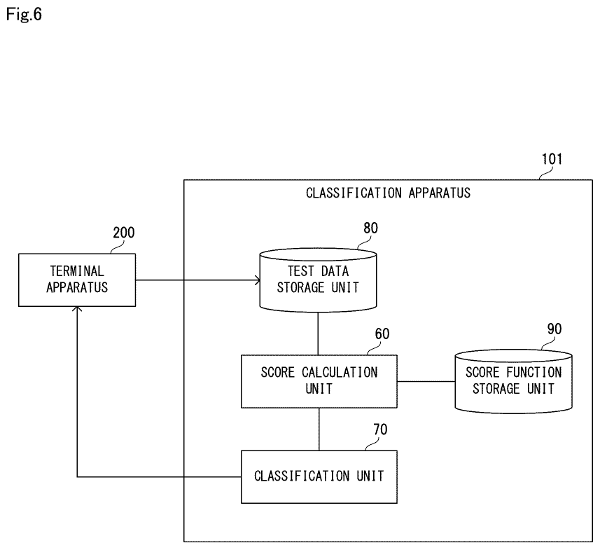

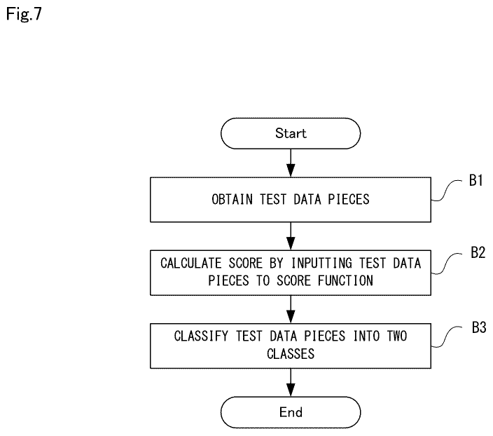

Next, a second example embodiment will be described in relation to a classification apparatus, a classification method, and a program for realizing them with reference to FIG. 6 and FIG. 7.

### Apparatus Configuration

First, a configuration of the classification apparatus according to the second example embodiment will be described using FIG. 6. FIG. 6 is a block diagram showing the configuration of the classification apparatus according to the second example embodiment.

A classification apparatus 101 according to the second example embodiment shown in FIG. 6 is an apparatus for classifying test data pieces into two classes with use of a score function. As shown in FIG. 6, in the second example embodiment, the classification apparatus 101 is connected to a terminal apparatus 200 in such a manner that data can be communicated therebetween, similarly to the first example embodiment. Specific examples of the terminal apparatus 200 include a general-purpose computer, a smartphone, a tablet-type terminal apparatus, and so forth. Note that in the second example embodiment, the terminal apparatus 200 inputs test data pieces to be classified into two classes to the classification apparatus 101. Also, as shown in FIG. 6, the classification apparatus 101 according to the second example embodiment includes a score calculation unit 60, a classification unit 70, a test data storage unit 80, and a score function storage unit 90. Among these, the test data storage unit 80 stores input test data pieces.

The score function storage unit 90 stores a score function used in binary classification. The score function is a score function for which the parameter has been updated in accordance with the first example embodiment, and is obtained in the following procedure.

First, the lowest one of the scores calculated for positive examples is used as a minimum score, the highest one of the scores calculated for negative example data pieces is used as a maximum score, and training data pieces for which the calculated scores are equal to or higher than the minimum score and equal to or lower than the maximum score are selected from among positive example data pieces and from among negative example data pieces. Next, a group of pairs of a positive example and a negative example is generated from the selected training data pieces. Then, machine learning of the parameter of the score function is performed so as to, with regard to the generated group of pairs, increase the number of pairs in which the score of positive example data is higher than the score of negative example data; in this way, the score function is obtained.

The score calculation unit 60 obtains the score function from the score function storage unit 90, and calculates scores by inputting test data pieces extracted from the test data storage unit to the obtained score function. Note that the score calculation unit 60 according to the second example embodiment has functions similar to the functions of the score calculation unit 10 according to the first example embodiment shown in FIG. 2.

The classification unit 70 classifies the test data pieces into two classes, for example, as positive examples or negative examples, based on the values of the scores calculated by the score calculation unit 60. Also, the classification unit 70 can transmit the classification result to the terminal apparatus 200.

### Apparatus Operations

Next, the operations of the classification apparatus 101 according to the second example embodiment will be described using FIG. 7. FIG. 7 is a flow diagram showing the operations of the classification apparatus according to the second example embodiment. In the following description, FIG. 6 will be referred to as appropriate. Also, in the second example embodiment, the classification method is implemented by causing the classification apparatus 101 to operate. Therefore, the following description of the operations of the classification apparatus 101 applies to the classification method according to the second example embodiment.

As shown in FIG. 7, first, the score calculation unit 60 obtains test data pieces from the test data storage unit 80 (step B1).

Next, the score calculation unit 60 obtains the score function from the score function storage unit 90, and calculates scores by inputting the test data pieces obtained in step B1 to the obtained score function (step B2). Next, the classification unit 70 classifies the test data pieces into two classes, for example,

as positive examples or negative examples, based on the values of the scores calculated in step B2 (step B3). Specifically, the classification unit 70 classifies test data as a positive example in a case where the value of the score is larger than a threshold, and classifies test data as a negative example in a case where the value of the score is equal to or smaller than the threshold. Also, the classification unit 70 transmits the classification result to the terminal apparatus 200.

As described above, according to the second example embodiment, test data pieces can be classified into two classes with use of the score function for which the parameter has been updated in accordance with the first example embodiment. Therefore, high classification accuracy can be achieved.

### Program

It suffices for a program in the second example embodiment to be a program that causes a computer to carry out steps B1 to B3 shown in FIG. 7. Also, by this program being installed and executed in the computer, the classification apparatus 101 and the classification method according to the second example embodiment can be realized. In this case, a processor of the computer functions and performs processing as the score calculation unit 60 and the classification unit 70.

In the second example embodiment, the test data storage unit 80 and the score function storage unit 90 may be realized by a storage device such as a hard disk provided in the computer, or may be realized by a storage device of another computer. The computer includes general-purpose PC, smartphone and tablet-type terminal device.

The program according to the second example embodiment may be executed by a computer system constructed with a plurality of computers. In this case, for example, each computer may function as one of the score calculation unit 60 and the classification unit 70.

### Physical Configuration

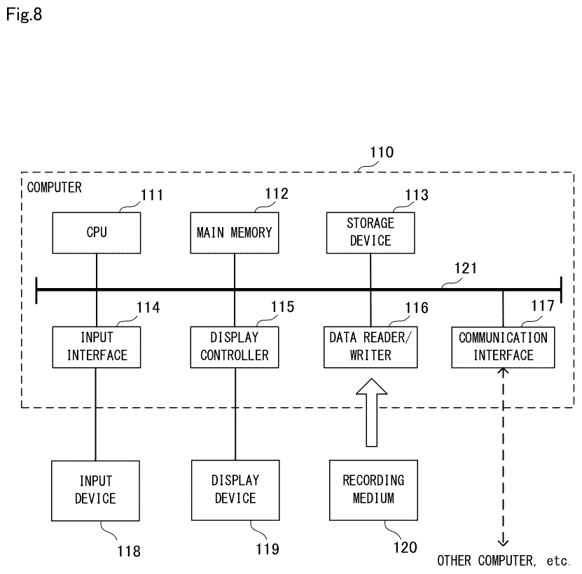

Using FIG. 8, the following describes a computer that realizes each apparatus by executing the program according to the first or second example embodiment. FIG. 8 is a block diagram illustrating an example of a computer that realizes the learning apparatus according to the first example embodiment and the classification apparatus according to the second example embodiment.

As shown in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. The computer 110 may include a GPU (Graphics Processing Unit) or an FPGA (Field-

Programmable Gate Array) in addition to the CPU 111, or in place of the CPU 111. In this case, the GPU or the FPGA can execute the programs according to the example embodiment.

The CPU 111 deploys the program (codes) according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the present example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the learning apparatus 100 according to the first example embodiment and the classification apparatus 101 according to the second example embodiment can also be realized by using items of hardware that respectively correspond to the components, such as a circuit, rather than the computer in which the program is installed. Furthermore, a part of the learning apparatus 100 according to the first example embodiment and the classification apparatus 101 according to the second example embodiment may be realized by the program, and the remaining part of the learning apparatus 100 and the classification apparatus 101 may be realized by hardware.

In the example embodiment, a pair group limited by the minimum score and the maximum score is targeted. However, the example invention is effective even for pair groups within the range of maximum score ±αor minimum score ±α. “α” is a positive real number.

A part or an entirety of the above-described example embodiment can be represented by (Supplementary Note 1) to (Supplementary Note 12) described below but is not limited to the description below.

### Supplementary Note 1

A learning apparatus for performing machine learning of a score function for binary classification, the learning apparatus comprising:
a score calculation unit that calculates scores by inputting, to the score function, a plurality of training data pieces to which labels of positive examples or negative examples have been added;
a score specification unit that specifies the lowest one of the scores that have been calculated for the training data pieces to which the labels of positive examples have been added as a minimum score, and specifies the highest one of the scores that have been calculated for the training data pieces to which the labels of negative examples have been added as a maximum score;
a pair generation unit that selects, from among the training data pieces to which the labels of positive examples have been added and from among the training data pieces to which the labels of negative examples have been added, training data pieces for which the calculated scores are equal to or higher than the minimum score and equal to or lower than the maximum score, and generates a group of pairs of a positive example and a negative example from the selected training data pieces; and
an optimization unit that updates a parameter of the score function through machine learning so as to, with regard to the generated group of pairs, increase the number of pairs in which a score of training data to which a label of a positive example has been added is higher than a score of training data to which a label of a negative example has been added.

### Supplementary Note 2

The learning apparatus according to Supplementary Note 1, wherein
the pair generation unit: randomly selects, from among the training data pieces to which the labels of positive examples have been added and from among the training data pieces to which the labels of negative examples have been added, a set number of training data pieces for which the calculated scores are equal to or higher than the minimum score and equal to or lower than the maximum score; and generates the group of pairs composed of the set number of pairs from the selected training data pieces.

### Supplementary Note 3

The learning apparatus according to Supplementary Note 1, wherein
the pair generation unit: selects, from among the generated pairs, pairs in which a score of training data to which a label of a positive example has been added is lower than a score of training data to which a label of a negative example has been added; further ultimately selects a set number of pairs randomly from among the selected pairs; and generates the group of pairs composed of the ultimately selected pairs.

### Supplementary Note 4

A trained model generation method for performing machine learning of a score function for binary classification, the trained model generation method comprising:
a score calculation step of calculating scores by inputting, to the score function, a plurality of training data pieces to which labels of positive examples or negative examples have been added;
a score specification step of specifying the lowest one of the scores that have been calculated for the training data pieces to which the labels of positive examples have been added as a minimum score, and specifying the highest one of the scores that have been calculated for the training data pieces to which the labels of negative examples have been added as a maximum score;
a pair generation step of selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces; and
an optimization step of updating a parameter of the score function through machine learning so as to, with regard to the generated group of pairs, increase the number of pairs in which a score of training data to which a label of a positive example has been added is higher than a score of training data to which a label of a negative example has been added.

### Supplementary Note 5

The trained model generation method according to Supplementary Note 4, wherein
in the pair generation step: a set number of training data pieces for which the calculated scores are equal to or higher than the minimum score and equal to or lower than the maximum score are randomly selected from among the training data pieces to which the labels of positive examples have been added and from among the training data pieces to which the labels of negative examples have been added; and the group of pairs composed of the set number of pairs is generated from the selected training data pieces.

### Supplementary Note 6

The trained model generation method according to Supplementary Note 4, wherein
in the pair generation step: pairs in which a score of training data to which a label of a positive example has been added is lower than a score of training data to which a label of a negative example has been added, are selected from among the generated pairs; a set number of pairs are further ultimately selected randomly from among the selected pairs; and the group of pairs composed of the ultimately selected pairs is generated.

### Supplementary Note 7

A computer readable recording medium that includes a program recorded thereon, the program being intended to cause a computer to perform machine learning of a score function for binary classification and including instructions that cause the computer to carry out:
a score calculation step of calculating scores by inputting, to the score function, a plurality of training data pieces to which labels of positive examples or negative examples have been added;
a score specification step of specifying the lowest one of the scores that have been calculated for the training data pieces to which the labels of positive examples have been added as a minimum score, and specifying the highest one of the scores that have been calculated for the training data pieces to which the labels of negative examples have been added as a maximum score;
a pair generation step of selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces; and
an optimization step of updating a parameter of the score function through machine learning so as to, with regard to the generated group of pairs, increase the number of pairs in which a score of training data to which a label of a positive example has been added is higher than a score of training data to which a label of a negative example has been added.

### Supplementary Note 8

The computer readable recording medium according to Supplementary Note 7, wherein
in the pair generation step: a set number of training data pieces for which the calculated scores are equal to or higher than the minimum score and equal to or lower than the maximum score are randomly selected from among the training data pieces to which the labels of positive examples have been added and from among the training data pieces to which the labels of negative examples have been added; and the group of pairs composed of the set number of pairs is generated from the selected training data pieces.

### Supplementary Note 9

The computer readable recording medium according to Supplementary Note 7, wherein
in the pair generation step: pairs in which a score of training data to which a label of a positive example has been added is lower than a score of training data to which a label of a negative example has been added, are selected from among the generated pairs; a set number of pairs are further ultimately selected randomly from among the selected pairs; and the group of pairs composed of the ultimately selected pairs is generated.

### (Supplementary Note 10

A classification apparatus, comprising:
a score calculation unit that calculates scores by inputting test data pieces to a score function; and
a classification unit that classifies the test data pieces into two classes based on values of the calculated scores,
wherein
the score function is a function obtained by
   using the lowest one of scores that have been calculated for training data pieces to which labels of positive examples have been added as a minimum score, and using the highest one of scores that have been calculated for training data pieces to which labels of negative examples have been added as a maximum score,
   selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces, and
performing machine learning of a parameter of the score function so as to, with regard to the generated group of pairs, increase the number of pairs in which a score of training data to which a label of a positive example has been added is higher than a score of training data to which a label of a negative example has been added.

### Supplementary Note 11

A classification method, comprising:
a score calculation step of calculating scores by inputting test data pieces to a score function; and
a classification step of classifying the test data pieces into two classes based on values of the calculated scores,
wherein
the score function is a function obtained by
   using the lowest one of scores that have been calculated for training data pieces to which labels of positive examples have been added as a minimum score, and using the highest one of scores that have been calculated for training data pieces to which labels of negative examples have been added as a maximum score,
   selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces, and
   performing machine learning of a parameter of the score function so as to, with regard to the generated group of pairs, increase the number of pairs in which a score of training data to which a label of a positive example has been added is higher than a score of training data to which a label of a negative example has been added.

### Supplementary Note 12

A computer readable recording medium that includes a program recorded thereon, the program including instructions that cause a computer to carry out:
a score calculation step of calculating scores by inputting test data pieces to a score function; and
a classification step of classifying the test data pieces into two classes based on values of the calculated scores,
wherein
the score function is a function obtained by
   using the lowest one of scores that have been calculated for training data pieces to which labels of positive examples have been added as a minimum score, and using the highest one of scores that have been calculated for training data pieces to which labels of negative examples have been added as a maximum score,
   selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces, and
   performing machine learning of a parameter of the score function so as to, with regard to the generated group of pairs, increase the number of pairs in which a score of training data to which a label of a positive example has been added is higher than a score of training data to which a label of a negative example has been added.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to shorten a time period required for machine learning in machine learning of a parameter of a score function used in binary classification. The invention is useful in a variety of systems where binary classification is performed.

### REFERENCE SIGNS LIST

10 Score calculation unit
20 Score specification unit
30 Pair generation unit
40 Optimization unit
50 Training data storage unit
60 Score calculation unit
70 Classification unit
80 Test data storage unit
90 Score function storage unit
100 Learning apparatus
101 Classification apparatus
110 Computer
111 CPU
112 Main memory
113 Storage device
114 Input interface
115 Display controller
116 Data reader/writer
117 Communication interface
118 Input device
119 Display device
120 Recording medium
121 Bus
200 Terminal apparatus

What is claimed is:

1. A learning apparatus for performing machine learning of a score function for binary classification, the learning apparatus comprising:
at least one memory storing instructions; and
at least one processor configured to execute the instructions to:
calculate scores by inputting, to the score function, a plurality of training data pieces to which labels of positive examples or negative examples have been added;
specify the lowest one of the scores that have been calculated for the training data pieces to which the labels of positive examples have been added as a minimum score, and specify the highest one of the scores that have been calculated for the training data pieces to which the labels of negative examples have been added as a maximum score;
, select, from among the training data pieces to which the labels of positive examples have been added and from among the training data pieces to which the labels of negative examples have been added, training data pieces for which the calculated scores are equal to or higher than the minimum score and equal to or lower than the maximum score, and generate a group of pairs of a positive example and a negative example from the selected training data pieces; and
update a parameter of the score function through machine learning so as to, with regard to the generated group of pairs, increase the number of pairs in which a score of training data to which a label of a positive example has been added is higher than a score of training data to which a label of a negative example has been added.

2. The learning apparatus according to claim 1, wherein further at least one processor configured to execute the instructions to:
select, from among the training data pieces to which the labels of positive examples have been added and from among the training data pieces to which the labels of negative examples have been added, a set number of training data pieces for which the calculated scores are equal to or higher than the minimum score and equal to or lower than the maximum score; and generate the group of pairs composed of the set number of pairs from the selected training data pieces.

3. The learning apparatus according to claim 1, wherein
further at least one processor configured to execute the instructions to:
select, from among the generated pairs, pairs in which a score of training data to which a label of a positive example has been added is lower than a score of training data to which a label of a negative example has been added; further ultimately select a set number of pairs randomly from among the selected pairs; and generate the group of pairs composed of the ultimately selected pairs.

4. A trained model generation method for performing machine learning of a score function for binary classification, the trained model generation method comprising:
calculating scores by inputting, to the score function, a plurality of training data pieces to which labels of positive examples or negative examples have been added;
specifying the lowest one of the scores that have been calculated for the training data pieces to which the labels of positive examples have been added as a minimum score, and specifying the highest one of the scores that have been calculated for the training data pieces to which the labels of negative examples have been added as a maximum score;
selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces; and
updating a parameter of the score function through machine learning so as to, with regard to the generated group of pairs, increase the number of pairs in which a score of training data to which a label of a positive example has been added is higher than a score of training data to which a label of a negative example has been added.

5. The trained model generation method according to claim 4, wherein
in the generation of the group of pairs: a set number of training data pieces for which the calculated scores are equal to or higher than the minimum score and equal to or lower than the maximum score are randomly selected from among the training data pieces to which the labels of positive examples have been added and from among the training data pieces to which the labels of negative examples have been added; and the group of pairs composed of the set number of pairs is generated from the selected training data pieces.

6The trained model generation method according to claim 4, wherein
in the generation of the group of pairs: pairs in which a score of training data to which a label of a positive example has been added is lower than a score of training data to which a label of a negative example has been added, are selected from among the generated pairs; a set number of pairs are further ultimately selected randomly from among the selected pairs; and the group of pairs composed of the ultimately selected pairs is generated.

7. A non-transitory computer readable recording medium that includes a program recorded thereon, the program being intended to cause a computer to perform machine learning of a score function for binary classification and including instructions that cause the computer to carry out:
calculating scores by inputting, to the score function, a plurality of training data pieces to which labels of positive examples or negative examples have been added;
specifying the lowest one of the scores that have been calculated for the training data pieces to which the labels of positive examples have been added as a minimum score, and specifying the highest one of the scores that have been calculated for the training data pieces to which the labels of negative examples have been added as a maximum score;
selecting, from among the training data pieces to which the labels of positive examples have been added and from among the training data pieces to which the labels of negative examples have been added, training data pieces for which the calculated scores are equal to or higher than the minimum score and equal to or lower than the maximum score, and generating a group of pairs of a positive example and a negative example from the selected training data pieces; and
updating a parameter of the score function through machine learning so as to, with regard to the generated group of pairs, increase the number of pairs in which a score of training data to which a label of a positive example has been added is higher than a score of training data to which a label of a negative example has been added.

8. The non-transitory computer readable recording medium according to claim 7, wherein
in the generating of a group of pairs: a set number of training data pieces for which the calculated scores are equal to or higher than the minimum score and equal to or lower than the maximum score are randomly selected from among the training data pieces to which the labels of positive examples have been added and from among the training data pieces to which the labels of negative examples have been added; and the group of pairs composed of the set number of pairs is generated from the selected training data pieces.

9. The non-transitory computer readable recording medium according to claim 7, wherein
in the generating of a group of pairs: pairs in which a score of training data to which a label of a positive example has been added is lower than a score of training data to which a label of a negative example has been added, are selected from among the generated pairs; a set number of pairs are further ultimately selected randomly from among the selected pairs; and the group of pairs composed of the ultimately selected pairs is generated.

10-12. (canceled)
